(19) United States
(12) Patent Application Publication
(10) Pub. No.: US 2002/0057363 A1
(43) Pub. Date: May 16, 2002

(54) Image data conversion method and apparatus for converting compressed image data to image data of different format

(76) Inventors: Satoru Todate, Kodaira (JP); Haruhiro Koto, Tokorozawa (JP); Yuichi Onami, Iruma (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/987,580

(22) Filed: Nov. 15, 2001

(30) Foreign Application Priority Data
Nov. 15, 2000 (JP) 2000-348710
Jun. 27, 2001 (JP) 2001-195428

(51) Int. Cl. H04N 7/01

(52) U.S. Cl. 348/441

(57) ABSTRACT

An image data conversion method and apparatus capable of real time output of moving pictures and simplifying the control circuit. This apparatus includes a central processing unit (CPU) for decoding compressed data and transferring the decoded data at the same line frequency as that of a receiver, and an image inverse-conversion processor for converting the data transferred from the CPU to an image size that can be displayed on the receiver. The CPU controls the decoded data so that it is decimated by eliminating predetermined lines so as to have the same number of lines as that of the receiver displaying apparatus, and be transferred to the image inverse-conversion processor. The image inverse-conversion processor includes a converter circuit common to the conversion to odd and even fields.

### BACKGROUND OF THE INVENTION

The present invention relates to image data conversion, and particularly to a data conversion apparatus and an image data conversion method for converting compressed image data to image data of a different format and displaying the converted image data on a display apparatus.

A compression system for moving picture data, MPEG-4, has begun to be used in the field of mobile communication with its transmission band limited. To transmit the picture of MPEG-4 at a low bit rate, moving picture data of, for example, SDTV (Standard Definition TV) type is converted to a CIF (Common Intermediate Format) of about ¼ size, and the CIF image is compressed and then transmitted as compressed data.

On the receiving side, the compressed data of CIF is expanded, and inversely converted into the original SDTV-type moving picture data.

### SUMMARY OF THE INVENTION

When resolution conversion processing as in the above conversion to CIF is performed on hardware, data of one line is recorded in a memory, and converted using data one line or a few lines after the recorded one-line data. Thus, the hardware control for reading data from and writing data in the memory becomes complicated.

In addition, each frame of CIF is formed of one field, and each frame of SDTV is formed of two fields of odd and even fields.

Thus, in order to make image conversion processing from the one-frame one-field structure's resolution to the one-frame two-fields structure's resolution as in the conversion from CIF to SDTV, it is necessary to do conversion processing such that odd and even fields are produced from each field before conversion.

FIG. 2 shows an example of the moving picture transmission apparatus using MPEG-4. This arrangement is devised by the inventors in the course of working for the present invention.

Referring to FIG. 2, a camera 2-1 produces a moving picture as SDTV data 2-2. The camera 2-1 may be recording media having various moving picture data stored depending on the construction of the apparatus.

An image conversion processor 2-3 receives the SDTV data 2-2 and makes image conversion to produce CIF data 2-4. A central processing unit (CPU) 2-5 compresses the CIF data 2-4 and controls transmission data 2-6 to be produced. The transmission data 2-6 is transmitted via a transmission path 1-1 to a CPU 2-7, which receives it as reception data 1-2.

The CPU 2-7 expands the compressed data that is received as reception data 1-2, and controls a memory 2-9 to write it and to produce CIF data 2-10. The data transfer by these sequential operations is performed through a data bus 2-8.

An image inverse-conversion processor 2-11 inversely converts the CIF data 2-10 to produce SDTV data 1-8, and supplies it to a receiver (monitor) 1-9.

A description will be made of an image processing method for converting SDTV data 2-2 to CIF data 2-4 and converting CIF data 2-10 to SDTV data 1-8.

The SDTV data 2-2 produced from the camera 2-1 is moving picture data of 480 lines per frame. The image conversion processor 2-3 thins out the SDTV data 2-2 of 480 lines per frame, thus eliminating one field of each frame from the SDTV data to produce data of 240 lines per frame. The processor also divides the 240 lines per frame 5 lines by 5 lines, and generates data of 6 lines from data of every 5 lines by conversion processing, so that the CIF data 2-4 of 288 lines per frame can be produced from the processor 2-3.

The image inverse-conversion processor 2-11 receives the CIF data 2-10 of 288 lines per frame, and generates data of 5 lines from data of 6 lines so that data of 240 lines per frame can be produced. The data of 240 lines per frame is used as one field of the SDTV data 1-8, and the other field data is obtained by reading out the same CIF data 2-10 from the memory 2-9 under the control of the CPU 2-7. These two field data are combined to form the SDTV data 1-8, which is supplied to the monitor 1-9.

Here, the monitor 1-9 displays the moving picture. In order to display the complete moving picture, it is necessary that the moving picture data of a fixed rate required by the monitor 1-9 be continuously supplied to the monitor 1-9.

Therefore, the SDTV 1-8 that the image reverse-conversion processor 2-11 generates is also required to be produced at a fixed rate incessantly.

Here, since the SDTV data 1-8 is made from the CIF data 2-10 fed to the image inverse-conversion processor 2-11, the input timing of the CIF data is determined by the SDTV data 1-8. The conversion from the CIF data 2-10 to the SDTV data 1-8 is performed line by line, and the output timing of the SDTV data 1-8 is used as a reference. Therefore, during the interval in which 5 lines of the SDTV data 1-8 are produced, data of 6 lines of the CIF data 2-10, one line more than the SDTV, must be supplied to the image inverse-conversion processor 2-11.

A method of converting 6-line data to 5-line data (hereinafter, referred to as 6-5 conversion) as an example of the image conversion will be described below.

FIG. 3 shows the gravity centers of lines before and after the 6-5 conversion, and conversion coefficients. Here, lines 3-1, 3-2, 3-3, 3-4, 3-5, 3-6, 3-7 indicate the gravity centers of lines of CIF data before the 6-5 conversion, and lines 3-8, 3-9, 3-10, 3-11, 3-12, 3-13 the gravity centers of lines of SDTV data after the 6-5 conversion. The values indicated under the lines 3-8, 3-9, 3-10, 3-11, 3-12, 3-13 of SDTV data are the conversion coefficients for use in the conversion from the CIF data to the SDTV data.

Here, the “gravity center” means the physical position of line on the screen or picture, and the “conversion coefficient” is the addition ratio that is used when image data of two lines before the 6-5 conversion are subjected to weighted averaging to produce image data of one line after the 6-5 conversion. In the example of in FIG. 3, the data of line 3-8 after the 6-5 conversion is generated by adding data of lines 3-1 and 3-2 before the 6-5 conversion at a ratio of 10:0. The data of line 3-9 after the 6-5 conversion is generated by adding data of lines 3-2 and 3-3 before the 6-5 conversion at a ratio of 8:2. Thereafter, the data of line 3-10 after the 6-5 conversion is generated by adding data of lines 3-3 and 3-4 before the 6-5 conversion at a ratio of 6:4, the data of line 3-11 by adding data of lines 3-4 and 3-5 before the 6-5 conversion at a ratio of 4:6, and the data of line 3-12 by adding data of lines 3-5 and 3-6 before the 6-5 conversion at a ratio of 2:8. The line 3-13 and the following after the 6-5 conversion are generated by repeating the above conversion method.

FIG. 4 shows the flow of CIF data fed, and the flow of SDTV data produced with respect to time in the 6-5 conversion of FIG. 3.

As shown in FIG. 4, the time elapses from left to right, and the line data are fed to and produced from the image inverse-conversion processor 2-11 since the 6-5 conversion is performed line by line.

In FIG. 4, lines 4-1, 4-2, 4-3, 4-4, 4-5, 4-6, 4-7 represent the lines of CIF data before the 6-5 conversion, and lines 4-8, 4-9, 4-10, 4-11, 4-12, 4-13 the lines of SDTV data after the 6-5 conversion.

First, the data of line 4-1 before the 6-5 conversion is supplied from the CPU 2-7 at an output rate for the monitor 1-9 during a one-line period, and stored in the memory 2-9. In the next line period, the data of line 4-2 before the 6-5 conversion is supplied from the CPU 2-7 so that the data of line 4-8 after the conversion can be generated from the line 4-1 stored in the memory 2-9 and the line 4-2 now fed from the CPU 2-7.

Thereafter, in this way, the data of line 4-9 after the 6-5 conversion is generated from the lines 4-2 and 4-3 at the output rate for the monitor 1-9 during the next line period, the data of line 4-10 from the lines 4-3 and 4-4, and the data of line 4-11 from the lines 4-4 and 4-5 at the same output rate during each line period.

However, in the sixth line period from the start of 6-5 conversion, two-line data of lines 4-6 and 4-7 before the 6-5 conversion are produced from the CPU 2-7.

In this line period, the data of line 4-12 after the 6-5 conversion is generated from the line 4-5 stored in the memory and the line 4-6 produced from the CPU 2-7. These line periods mentioned so far are treated as one cycle of 6-5 conversion, and the following conversion operations are performed by repeating this cycle.

Thus, the line 4-7 is processed as in the line 4-1, and the line 4-13 as in the line 4-8.

In the 6-5 conversion in which the line data after the conversion must be supplied at the monitor rate, an exceptional period in which two-line data are required to be read in during the one-line output time occurs at a rate of one line of 5 lines.

During each line period of the other four lines, data of one line is read in and compressed data of one line is expanded. These data reading-in and compressed-data expanding operations both use the data bus 2-8 in an almost occupied condition.

Therefore, in the exceptional period that occurs at a rate of one line of 5 lines, it is difficult to assure the time for the output control of two-line data from the CPU 2-7 and the expansion of the compressed data by the CPU 2-7 and thus to produce the moving picture in real time.

In addition, a special control circuit for this period is required in order to produce the two-line data during a one-line output period, thus complicating the circuit arrangement.

In summary, since the arrangement according to the above conversion method has the data bus occupied by the two-line data fed at the monitor rate during one line before the conversion, it is difficult to produce the moving picture in real time with the compressed data expanded. Moreover, since the data output must be controlled in an exceptional way at a rate of one line of every five lines, the control circuit arrangement becomes complicated.

Accordingly, it is a first object of the invention to provide an image data conversion apparatus capable of outputting moving picture in real time and simplifying the control circuit while removing these drawbacks and minimizing the effect on the picture quality after the conversion by changing the output timing of line data from the CPU to the image inverse-conversion processor and the image conversion coefficients.

By the way, when an image such as CIF data of which the frame is formed of one field is inversely converted to another type of image such as SDTV of which the frame is formed of two fields, the circuit used for the inverse conversion to odd fields is generally different from that to even fields and each image inverse-converter needs line memories of a large capacity, thereby enlarging the capacity of the line memories as well as enlarging the scale of the control circuit, to a problem.

Accordingly, it is a second object of the invention to provide an image data conversion method and apparatus capable of reducing the capacity of the line memories necessary for the image inverse-conversion processor and reducing the control circuit scale by removing these drawbacks and by using a circuit common to the circuits for the inverse conversion to odd and even fields.

According to one aspect of the invention, there is provided an image data conversion apparatus for converting transmitted compressed image data to image data of a different format and displaying the converted image data on a display apparatus, comprising:

a first signal processing unit for receiving and decoding the compressed image data;

a recording unit for recording the decoded image data, the recording unit reading out the image data one line by one line at a scanning line period of the display apparatus under control of the first signal processing unit; and

a second signal processing unit for converting image data read out of the recording unit to image data of a screen size of the display apparatus.

According to one feature of the invention, the first signal processing unit includes a decimation processing section for decimating the decoded image data to eliminate certain lines from the decoded image data so that image data of a same number of lines as that of the display apparatus be read out from the recording unit.

Thus, by decimating the decoded image data to eliminate predetermined lines so as to have the same number of lines as that of the display apparatus, and by transmitting the decimated image data to the second signal processing unit, it becomes possible to alleviate the occupation of CPU bus by the image data transfer.

Accordingly, the data bus can be prevented from being occupied by the image data transfer in terms of bus usage time, securing the data bus use time for the CPU so that it can use the data bus for data expansion, thus making it possible to produce moving pictures in real time.

Moreover, according to the invention, since the data transfer timing has a constant period, the controlling circuit for data transfer can be simplified.

According to another aspect of the invention, there is provided an image data conversion apparatus for converting compressed image data transferred in units of a field to image data of a different format so as to be displayed on a display apparatus, comprising:

a first signal processing unit for receiving the compressed image data in units of a field and decoding the compressed image data;

a recording unit for recording the decoded image data, the recording unit reading out the image data one line by one line at a scanning line period of the display apparatus under control of the first signal processing unit; and

a second signal processing unit for converting image data read out of the recording unit to image data of a screen size of the display apparatus, the second signal processing unit including an inverse converter for converting the image data of each field to an odd field image data and an even field image data.

According to one feature of the invention, the inverse converter includes a line memory by which the image data of each line read out from the recording unit is delayed by one line, and a digital filter that receives image data of a current line and the image data read one line before from the line memory, multiplies the both data by predetermined conversion coefficients, respectively, and then adds those data.

According to another feature of the invention, the first signal processing unit includes a decimation processing section that decimates the decoded image data to eliminate predetermined lines from the decoded image data so that image data having a same number of lines as that of an odd field or an even field of the display apparatus is read out from the recording unit.

According to still another feature of the invention, the predetermined lines eliminated from the image data are same lines for the odd and even fields.

Thus, according to the invention, when the decoded image is transferred, the decoded image data is decimated to eliminate predetermined lines so that the image data to be inversely converted can have the same line frequency as that of the display apparatus, thereby making the image inverse-conversion be the repetition of the same processing, and the conversion coefficients for use in the reverse conversion are changed in accordance with the lines to be inversely converted, thereby reducing the capacity of line memory for use in the inverse conversion, and the scale of the control circuit that controls the line memory to write.

### BRIEF DESCRIPTION OF THE DRAWINGS

The foregoing and other objects, features and advantages of the invention will be understood from the following more particular description of the embodiments of the invention as illustrated in the accompanying drawings wherein:

FIG. 1 is a block diagram of the arrangement of one embodiment of an image data conversion apparatus according to the invention.

FIG. 2 is a block diagram of the arrangement of an example of the image converter useful for explaining the invention.

FIG. 3 is a diagram showing the gravitation positions of lines before and after the 6-5 conversion, and conversion coefficients in the image converter of FIG. 2.

FIG. 4 is a diagram showing the flow of lines with respect to time before and after the 6-5 conversion of FIG. 3.

FIG. 5 is a diagram showing the gravitation positions of lines before and after the 6-5 conversion, and conversion coefficients in the embodiment of the invention.

FIG. 6 is a diagram showing the flow of lines with respect to time before and after the 6-5 conversion of FIG. 5.

FIG. 7 is a diagram showing an example of the image size in another image conversion to which the present invention can be applied.

FIG. 8 is a diagram showing the gravitation positions of lines before and after the conversion, and conversion coefficients to which the present invention is not applied, in the image conversion of FIG. 7.

FIG. 9 is a diagram showing the flow of lines with respect of time before and after the conversion of FIG. 8.

FIG. 10 is a diagram showing the gravitation positions of lines before and after the conversion, and conversion coefficients to which the present invention is applied, in the image conversion of FIG. 7.

FIG. 11 is a diagram showing the flow of lines with respect to time before and after the conversion of FIG. 10.

FIG. 12 is a diagram to which reference is made in explaining the image inverse-conversion processing in another embodiment of the invention.

FIG. 13 is a block diagram of the construction of a converter circuit for odd fields in the image inverse-conversion processing of the embodiment of FIG. 12.

FIG. 14 is a block diagram of the construction of a converter circuit for even fields in the image inverse-conversion processing of the embodiment of FIG. 12.

FIG. 15 is a diagram showing the gravitation positions of lines of odd fields and conversion coefficients before and after the image inverse-conversion of FIG. 13.

FIG. 16 is a diagram showing the gravitation positions of lines of even fields and conversion coefficients before and after the image inverse-conversion of FIG. 13.

FIG. 17 is a diagram showing the flow of lines with respect to time before and after the image inverse-conversion in the image inverse-conversion of FIG. 15.

FIG. 18 is a diagram showing the flow of lines with respect to time before and after the image inverse-conversion in the image inverse-conversion of FIG. 16.

FIG. 19 is a block diagram of the construction of a converter circuit for even fields in the image inverse-conversion processing of still another embodiment of the invention.

FIG. 20 is a diagram showing the gravitation positions of lines of even fields and conversion coefficients before and after the image conversion by the converter circuit of FIG. 19.

FIG. 21 is a diagram showing the flow of lines with respect to time before and after the conversion of FIG. 20.

FIG. 22 is a diagram useful for explaining the thinning out or decimating processing.

### DESCRIPTION OF THE EMBODIMENTS

Embodiments of the invention will be described with reference to the drawings. In the drawings, like elements are identified by the same reference numerals.

The construction of one embodiment of the image data conversion apparatus according to the invention will be described with reference to FIG. 1.

In FIG. 1, the reception data 1-2 such as compressed data is supplied from the transmission path 1-1 to a CPU (first signal processing unit) 1-3. The CPU 1-3 controls its expansion processing section 1-3-2 provided therein to expand the image of reception data (compressed data) 1-2, and a memory 1-6 to write and read CIF data 1-5.

The data transfer by these sequential operations of the CPU 1-3 is performed through a data bus 1-4.

An image inverse-conversion processor (second signal processing unit) 1-7 inversely converts the image of input CIF data 1-5, and supplies it as SDTV data 1-8 to the monitor 1-9.

Here, description will be described of the transition of line number between the blocks of FIG. 1.

The reception data 1-2 fed through the transmission path 1-1 is moving image data of 288 lines per frame. The CIF data 1-5 is processed for the 6-5 conversion by the image inverse-conversion processor 1-7 to produce the SDTV data 1-8 of 240 lines per frame.

While 5 lines of SDTV data are generated from 6 lines of CIF data by the 6-5 conversion processing as in the example of FIG. 3, the present invention employs a thinning out or decimating processing section 1-3-1 provided within CPU 1-3 by which the CIF data 1-5 is not produced with respect to one line out of every 6 lines.

Therefore, the image inverse-conversion processor 1-7 does not make the 6-5 conversion produce SDTV data 1-8 of 5 lines from CIF data 1-5 of 6 lines, but produce SDTV data 1-8 of 5 lines from CIF data 1-5 of 5 lines.

In other words, it produces SDTV data 1-8 of 240 lines per frame from CIF data 1-5 of 240 lines per frame.

In this case, both the image data of 240 lines are different in the gravitation positions of pixels. In addition, every two fields of the CIF data 1-5 of 240 lines per frame are produced under the control of the CPU 1-3 so that the SDTV data 1-8 of 480 lines per frame can be supplied from the image inverse-conversion processor 1-7 to the monitor 1-9.

In order to display a complete moving image on this monitor 1-9, it is necessary that the SDTV data be continuously supplied from the image inverse-conversion processor 1-7 to the monitor 1-9 at a fixed rate that the monitor 1-9 needs.

Moreover, since the SDTV data 1-8 is made from the CIF data 1-5 fed to the image inverse-conversion processor 1-7, the input timing of the CIF data is determined by the SDTV data 1-8.

In this case, since the conversion from CIF data 1-5 to SDTV data 1-8 is performed line by line on the basis of the output timing of SDTV data 1-8, the output rates of the CIF data 1-5 from the CPU 1-3 and the SDTV data 1-8 from the image inverse-conversion processor 1-7 are the same as that of the monitor 1-9.

While the CIF data 1-5 and SDTV data 1-8 are respectively fed and produced before and after the inverse-conversion processing as in FIG. 1, various types of image can be used as those data if the line numbers are converted as will be described later.

The 6-5 conversion will be described in detail. FIG. 5 shows the gravitation positions before and after the 6-5 conversion and conversion coefficients according to the invention.

Lines 3-1, 3-2, 3-3, 3-4, 3-5, 3-6, 3-7 represent the gravitation positions of lines of CIF data before the 6-5 conversion, and lines 3-8, 3-9, 3-10, 3-11, 5-1, 3-13 the gravitation positions of SDTV data after the 6-5 conversion.

The lines 3-8, 3-9, 3-10, 3-11 after the 6-5 conversion are generated by the same conversion method as shown in FIG. 3. The line 5-1 after the 6-5 conversion is generated by adding the data of lines 3-5 and 3-7 at a ratio of 6:4 with the line 3-6 not used. The line 3-13 and the following after the 6-5 conversion are generated by repeating the above conversion method.

FIG. 6 shows the flow of CIF data fed to be converted with respect to time, and the flow of SDTV data produced with respect to time in the 6-5 conversion of FIG. 5. In FIG. 6, time elapses from left to right. The 6-5 conversion is made line by line, and the image inverse-conversion processor 1-7 receives the lines of CIF data and produces the lines of SDTV data as in FIG. 6.

Lines 4-1, 4-2, 4-3, 4-4, 4-5, 4-6, 4-7 represent the lines of CIF data before the 6-5 conversion, and lines 4-8, 4-9, 4-10, 4-11, 6-1, 4-13 the lines of SDTV data after the 6-5 conversion.

First, the line 4-1 before the 6-5 conversion is produced from the CPU 1-3 at the same rate as the output rate to the monitor 1-9, and stored in the memory 1-6 during one line. In the next line period, the line 4-2 before the 6-5 conversion is produced from the CPU 1-3 and processed together with the line 4-1 stored in the memory 1-6 to produce the line 4-8 after the 6-5 conversion.

Thereafter, the data of line 4-9 after the 6-5 conversion is generated from the data of lines 4-2 and 4-3 before the 6-5 conversion, and fed at the output rate to the monitor 1-9 during one line period, the data of line 4-10 after the 6-5 conversion is produced from the lines 4-3 and 4-4 before the 6-5 conversion and fed during one line period, and the data of line 4-11 after the 6-5 conversion is produced from the data of lines 4-4 and 4-5 and fed during one line period.

However, during the sixth line period from the start of the 6-5 conversion, the CPU 1-3 controls its processor not to produce the line 4-6 but to produce data of line 4-7.

Thus, the data of line 6-1 as converted data is generated from the data of lines 4-5 and 4-7. The conversion operations mentioned so far are performed as one-cycle operation for the 6-5 conversion, and repeated for the next conversion. In other words, the line 4-7 is used for the conversion as is the line 4-1, and the line 4-13 is generated as is the line 4-8.

Under the control of this CPU 1-3, the rate at which the CIF data 1-5 is produced from the CPU 1-3 is the same as that of the SDTV data 1-8 to the monitor 1-9.

Therefore, the data bus that is used for the two purposes of both expansion of compressed data and data output in the CPU 1-3 can be prevented from being inoperative.

In addition, since the CIF data 1-5 of one line is produced at the same rate as the output rate to the monitor 1-9 during one line period, the same output control can be made at each line, and thus the control circuit can be simplified.

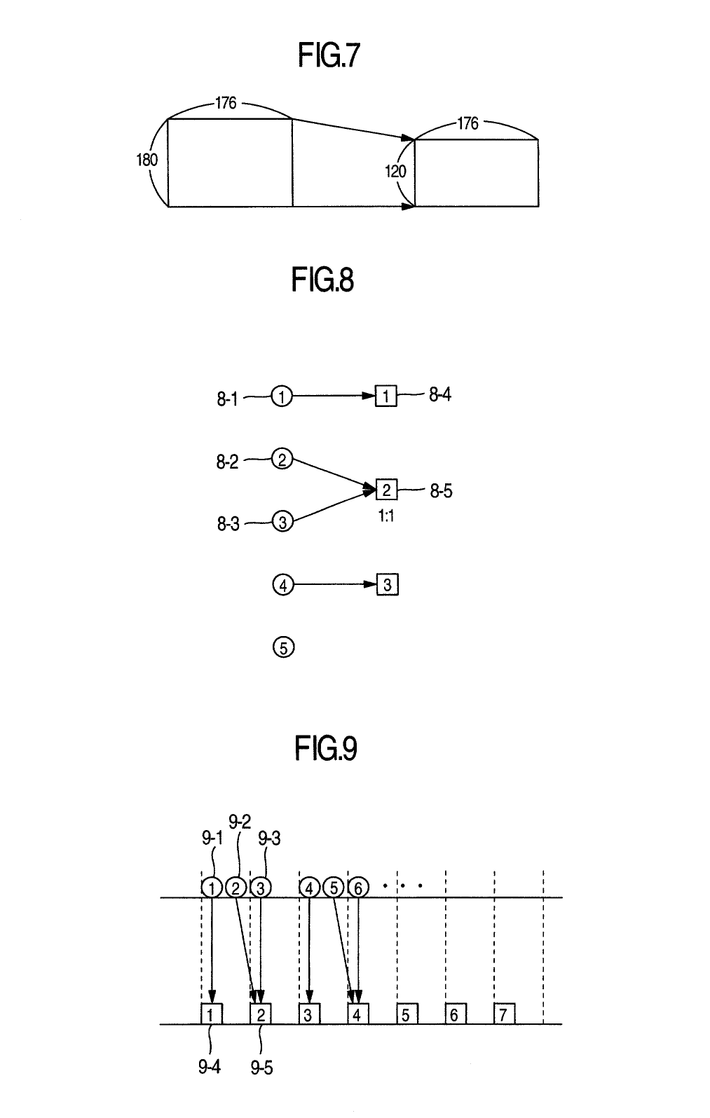

While explanation is made in the above in which the CIF data and SDTV data are used as data before and data after image inverse-conversion, respectively, the invention is not limited to the above, but may be applied to various types of data. As an example, explanation will now be made with reference to a case in which data before image inverse-conversion is QCIF data of 144 lines×176 pixels and data after image inverse-conversion is QSIF data of 120 lines×176 pixels. In this case, since 144:120=6:5, the 6-5 conversion explained with respect to FIGS. 5 and 6 can be applied. Further, as shown in FIG. 7, it is supposed that data before image inverse-conversion is constituted by 180 lines×176 pixels and data after image inverse-conversion is constituted by 120 lines×176 pixels. In this case, since 180:120:=3:2, conversion from 3 lines to 2 lines (hereinafter referred to as 3-2 conversion) is repeated.

FIG. 8 shows the gravitation positions of lines and conversion coefficients before and after the conversion to which the present invention is not applied. FIG. 9 shows the time flow in the conversion processing shown in FIG. 8. The data of line 8-1 (9-1) before the 3-2 conversion is produced directly as line 8-4 (9-4) after the 3-2 conversion. Lines 8-2 (9-2) and 8-3 (9-3) before the 3-2 conversion are added to produce a line 8-5 (9-5) after the conversion. The conversion processing made so far is treated as one cycle of the 3-2 conversion, and repeated with this period for further conversion. As will be understood from this operation, it is necessary that data of two lines 8-1 (9-1) and 8-2 (9-2) before the 3-2 conversion be produced in the first line period from the start of the 3-2 conversion. The same operation is also performed in the third line period. Only line 8-3 (9-3) is produced in the second line period from the start of the 3-2 conversion. These operations are irregular and not the simple repetition.

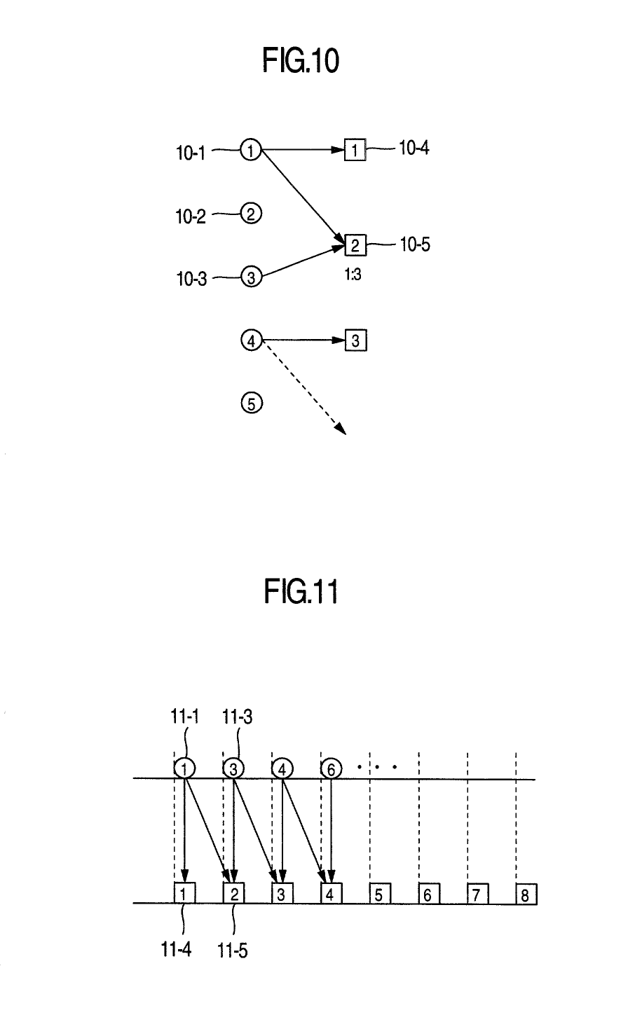

FIG. 10 shows the gravitation positions of lines and conversion coefficients before and after the conversion according to the invention. FIG. 11 shows the time flow in the conversion processing shown in FIG. 10. As illustrated in FIG. 10, data of line 10-1 (11-1) before the 3-2 conversion is produced directly as line 10-4 (11-4) after the 3-2 conversion with line 10-2 of data before the 3-2 conversion being removed, and the lines 10-1 (11-1) and 10-3 (11-3) are added to produce a line 10-5 (11-5). The operations made so far are treated as one cycle of the 3-2 conversion, and repeated with this period for further conversion. Therefore, this example has the same effect as does the case of 6-5 conversion.

It is a matter of course that the present invention can be applied to m-n conversion where n and m are positive integers.

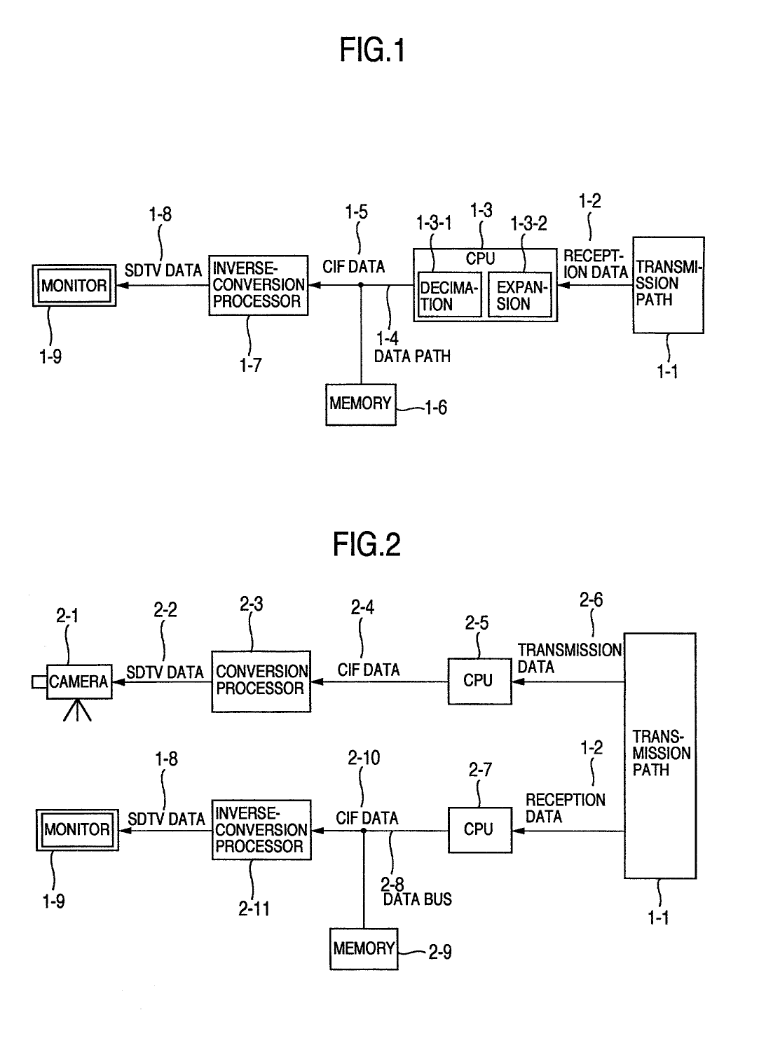

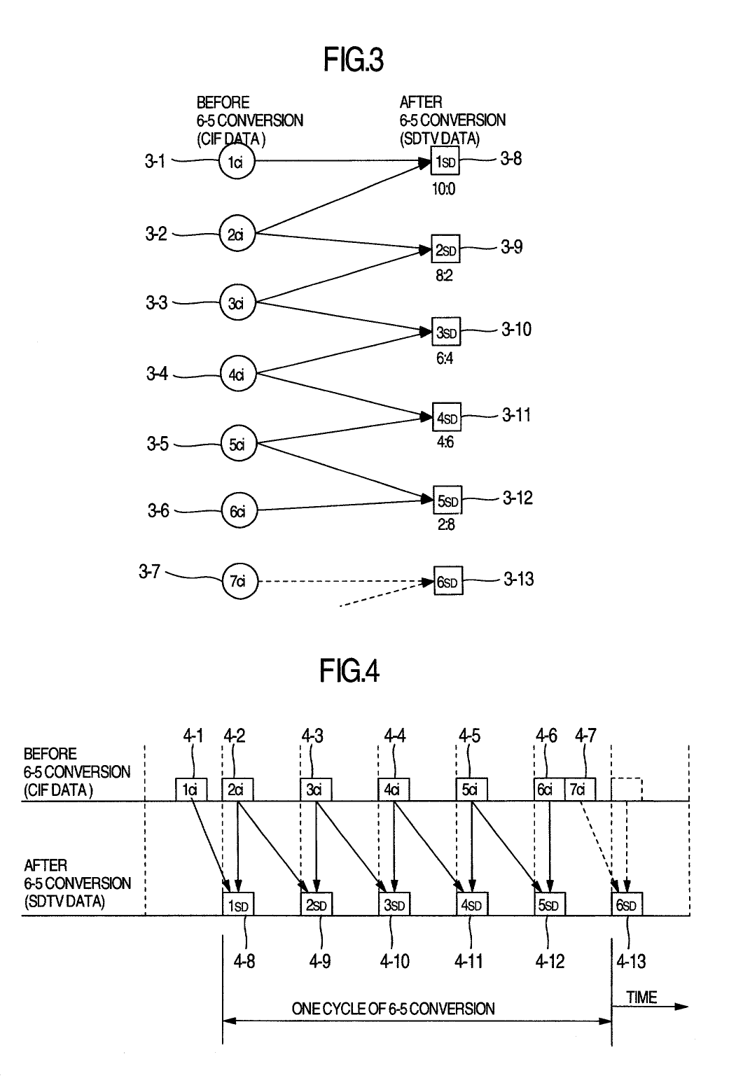

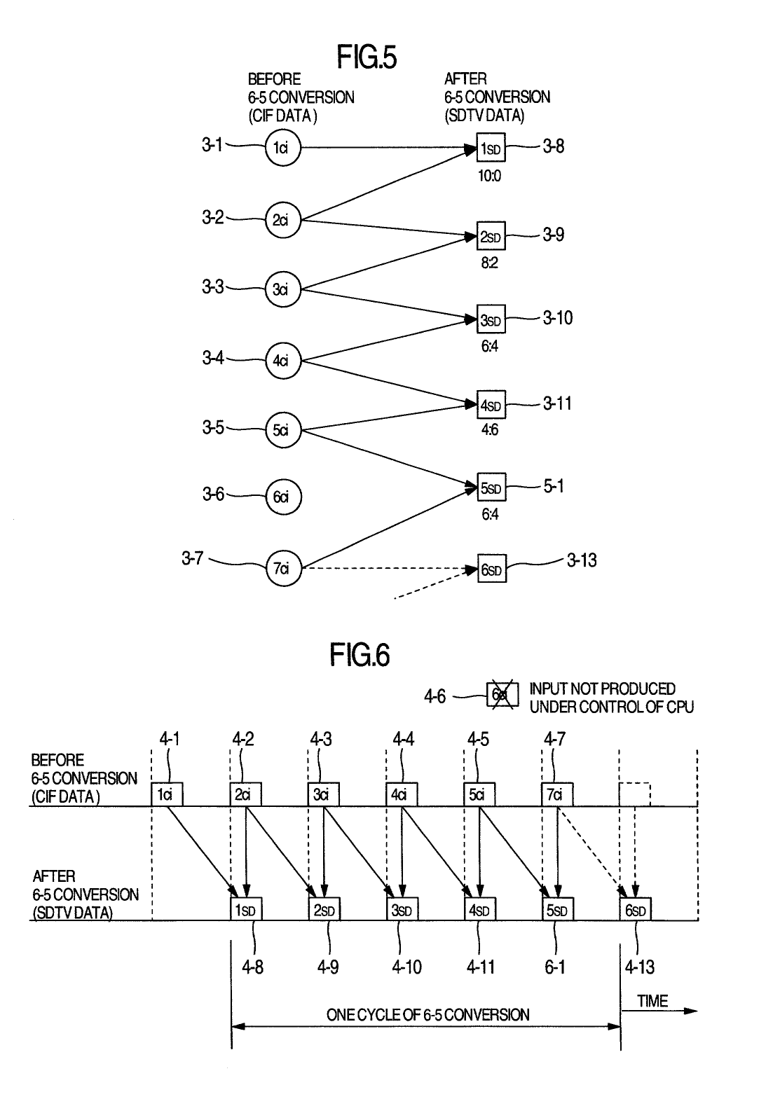

According to the above embodiment, the lines of the decoded data are controlled to be thinned out or decimated by a predetermined number of lines so that the number of the lines of the decoded data becomes the same as that of the monitor, and the decimated decoded data is transferred to the image inverse-conversion processor, thereby making it possible to reduce the rate of occupation of CPU data bus by image data transfer. Thus, the time of data bus usage can be prevented from being restricted by the image data transfer unlike the example shown in FIG. 2 through 4. The time of data bus usage can be assured for the expansion processing that the CPU makes, making it possible to produce moving pictures in real time. In addition, according to this embodiment, the data transfer timing has a fixed period, and hence the control circuit for data transfer can be simplified.

Another embodiment of the invention will be described with reference to FIGS. 1 and 2 and FIGS. 12 through 18. FIG. 1 shows the elements ranging from transmission path 1-1 to monitor 1-9 as part of the arrangement of FIG. 2. Since the remaining part of FIG. 1 is the same as in FIG. 2, it is not shown.

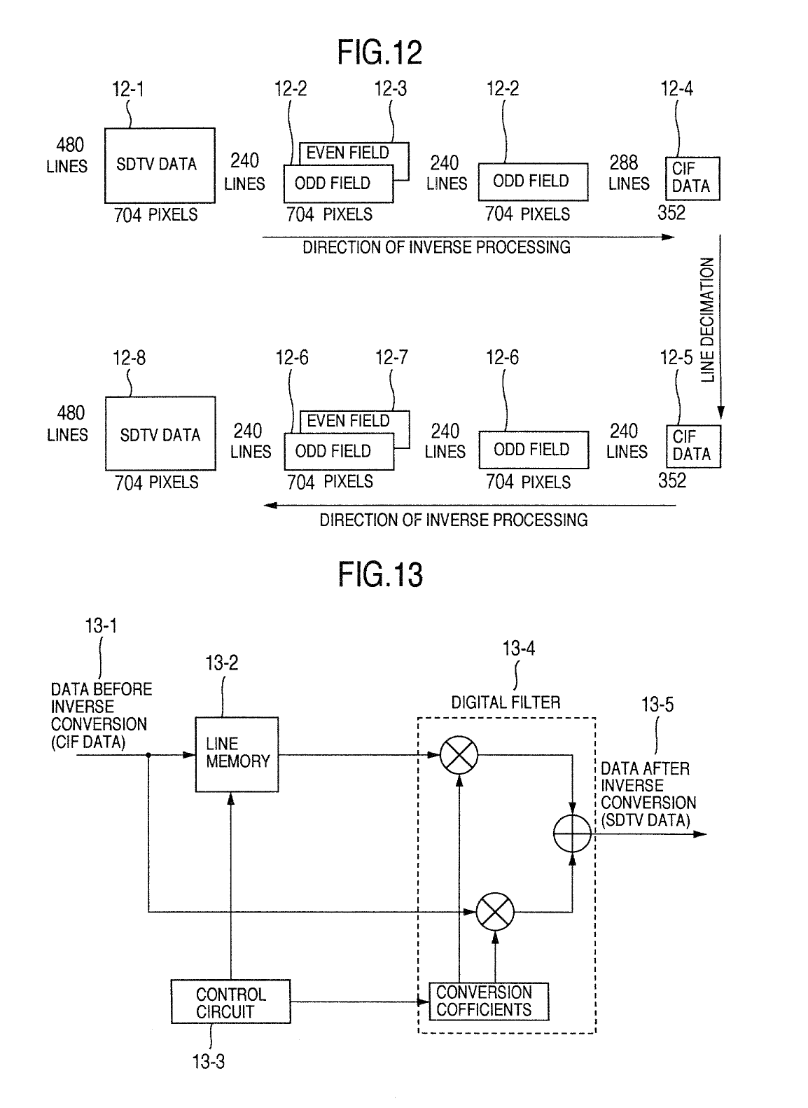

First, an image processing method for converting SDTV data 2-2 to CIF data 2-4 and inversely converting CIF data 1-5 to SDTV data 1-8 according to this embodiment will be further described in detail with reference to FIGS. 1, 2 and 12. FIG. 12 shows an image size at each stage of the processing.

The SDTV data generated from the camera 2-1 is shown as SDTV 12-1 of moving picture of which the size is 480 lines×704 pixels per frame. This SDTV data 12-1 is formed of two fields per frame each of which 240 lines×704 pixels.

The image conversion processor 2-3 makes one-field thinning out or decimating processing for eliminating 240-line data that constitutes the even field 12-3 of the SDTV data 12-1 of 480 lines×704 pixels to produce the odd field data 12-2 of 240 lines per frame. The 240 lines of this odd field data 12-2 are also partitioned every 5 lines, and 6-line data is generated from each 5 lines, so that the input data to the processor can be converted to CIF data 12-4 of 288 lines per frame.

On the other hand, the CPU 1-3 partitions the CIF data 12-4 of 288 lines per frame at every 6 lines, and eliminates one line from each section, thereby thinning out or decimating the CIF data of 288 lines into CIF data 12-5 of 240 lines, which is then supplied to the memory 1-6. The data of 240 lines stored in the memory 1-6 is transferred to the image inverse-conversion processor 1-7, and the processor makes inverse conversion, thereby producing odd-field data 12-6 of SDTV data 12-8.

Here, even when the even field data 12-7 is generated, the CIF data 12-5 produced by the line thinning out or decimating processing and stored in the memory 1-6 is again transferred to the image inverse-conversion processor 1-7 as described above.

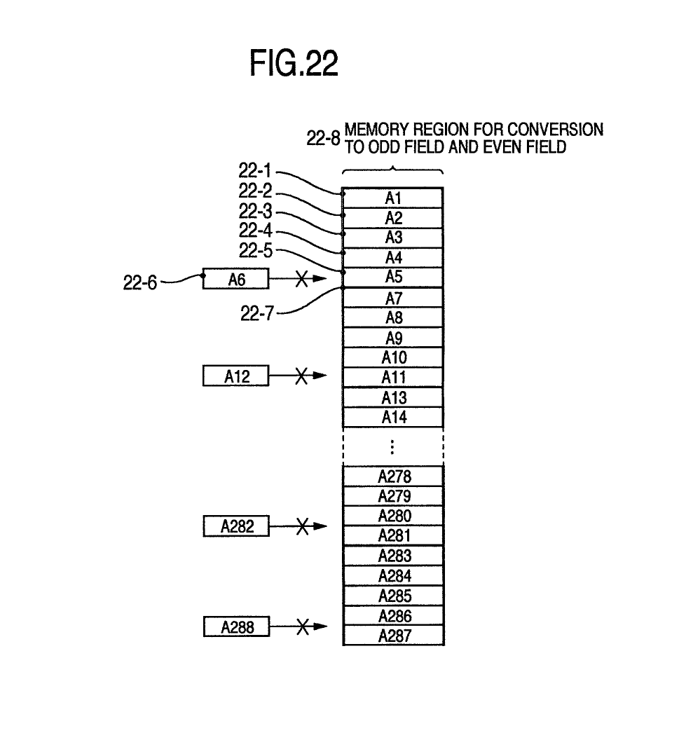

A method for thinning out or decimating lines will be described. FIG. 22 is a conceptional diagram for a memory thinning out or decimating method according to the invention.

Odd field conversion will be first described. Reference numerals 22-1, 22-2, 22-3, 22-4, 22-5, 22-6, 22-7 designate CIF data of each line for odd field/even field conversion, and 22-8 represents the odd-field/even-field conversion memory region of the memory 1-6. The CPU 1-3 sequentially produces each line data of the first five lines 22-1, 22-2, 22-3, 22-4, 22-5 of CIF data 1-5, and orders the memory to store those data in the odd-field/even-field conversion memory region 22-8.

Here, the sixth line data 22-6 of CIF data 1-5 is not produced as eliminated line data from the CPU 1-3. As to the seventh line 22-7 and the following data of CIF data 1-5, too, the cycle of the above 6-line data processing is repeated until the 288th line of CIF data 1-5.

The even-field conversion will be described next. In the even fields, the CPU 1-3 does not supply the CIF data 1-5 to the memory 1-6, but causes the memory to transfer to the image inverse-conversion processor 1-7 the data of 240 lines that have been stored in the memory 1-6 and used for odd-field conversion. This is equivalent to that the decimation processing in the even fields is applied to the same positions as the odd fields.

The CIF data stored in the memory 1-6 is converted to data of 240 lines per frame by the above thinning out, or decimating operation. Thus, the memory 1-6 for storing CIF data now may have a data region of one field though it needed a two-field region in the conventional example.

Accordingly, the processing time that the CPU takes to control the memory to write and the data bus occupation time can be halved. In addition, since the CPU can control the same thinning out or decimating processing on each of two fields, the data output control by the CPU can be simplified.

According to the above method, when the decoded data is thinned out by a predetermined number of lines so that the line frequency of the decoded data can be made equal to that of the receiver, the amount of data to be written in the memory can be reduced to half by removing the same lines from the data used in the odd field conversion and even field conversion. At the same time, the processing time that the CPU takes to control the memory to write and the data bus occupation time can be halved. Moreover, the output control by the CPU can be simplified.

Turning back to FIGS. 1, 2 and 12, the lines to be removed by the thinning out or decimating operation in the conversion to the even-field data are the same lines as removed in the conversion to the odd-field data as described above.

Thus, the even-field data 12-7 of the SDTV data 12-8 can be obtained by making inverse-conversion processing different from the odd-field conversion on the CIF data 12-5 of 240 lines transferred to the image inverse-conversion processor 1-7.

Since the line positions of the odd field pixels of the SDTV data 12-8 are different from those of the even field pixels, the inverse-conversion processing on the CIF data for the odd field is made differently from that for the even field as described above.

The image inverse-conversion processor 1-7 combines these two field data to form the SDTV data 12-8 of 480 lines per frame, and supplies it to the monitor 1-9.

In order that this monitor 1-9 can display complete moving pictures with no pixel and line dropped out, it is necessary that the SDTV data 1-8 of a constant rate which the monitor requires must be supplied from the image inverse-conversion processor 1-7 to the monitor 1-9.

Since the SDTV data 1-8 is derived from the CIF data fed to the inverse-conversion processor 1-7, the input timing of the CIF data is determined by the SDTV data 1-8. In other words, the output timing of the SDTV data 1-8 is used as a reference so that the inverse-conversion processing of the CIF data 1-5 into the SDTV data 1-8 can be carried out on the basis of the lines of the SDTV data 1-8. Thus, the CIF data 1-5 fed from the CPU 1-3 and the SDTV data 1-8 supplied from the image inverse-conversion processor 1-7 have the same line frequency as when the monitor 1-9 displays.

The circuit arrangement for the image inverse-conversion processor 1-7 will be described below. FIG. 13 shows a converter circuit for conversion to odd field data.

In FIG. 13, the image inverse-conversion processor 1-7 includes a line memory 13-2, a control circuit 13-3, and a digital filter 13-4. The data 13-1 to be inversely converted is supplied to the image inverse-conversion processor 1-7 each time the monitor 1-9 scans one line. The data 13-1 to be inversely converted is fed to the line memory 13-2 under the control of the control circuit 13-3, and then read to be delayed by one line from the line memory 13-2. The data delayed one line and the data 13-1 to be inversely converted are supplied to the digital filter 13-4, where those data are respectively multiplied by conversion coefficients and added together to form data 13-5, which is then fed as inversely converted data 13-5 from the processor 1-7.

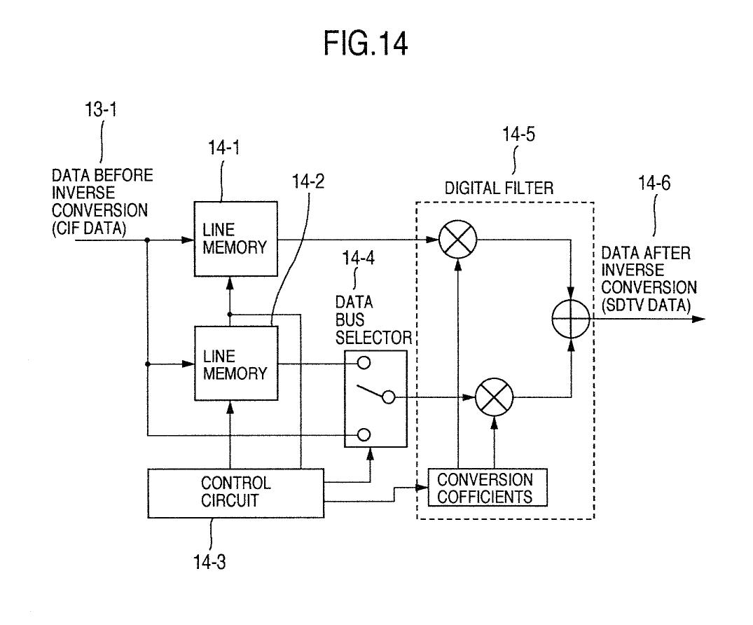

FIG. 14 shows a specific arrangement of the converter circuit for the conversion to the even-field data. The converter circuit for the conversion to the even field is different from that for the conversion to the odd field. That is, it includes line memories 14-1, 14-2, a control circuit 14-3, a data bus selector 14-4 and a digital filter 14-5. The data 13-1 to be inversely converted is fed to the image inverse-conversion processor 1-7 each time the monitor 1-9 scans one line.

The data 13-1 to be inversely converted is supplied to the line memories 14-1, 14-2 under the control of the control circuit 14-3, and then read to be delayed by one line or two lines from the line memories. At this time, the number of lines to be delayed depends on what number the even field to be generated ranks. The delayed data produced from the line memory 14-1, and the delayed data selected by the data bus selector 14-4 and produced from the line memory 14-2 or the data 13-1 not delayed and to be inversely converted are supplied to the digital filter 14-5, where those data are multiplied by conversion coefficients different from those for the conversion to the odd field, and added together to form data 14-6, which is then supplied as inversely converted data from the processor 1-7 to the outside.

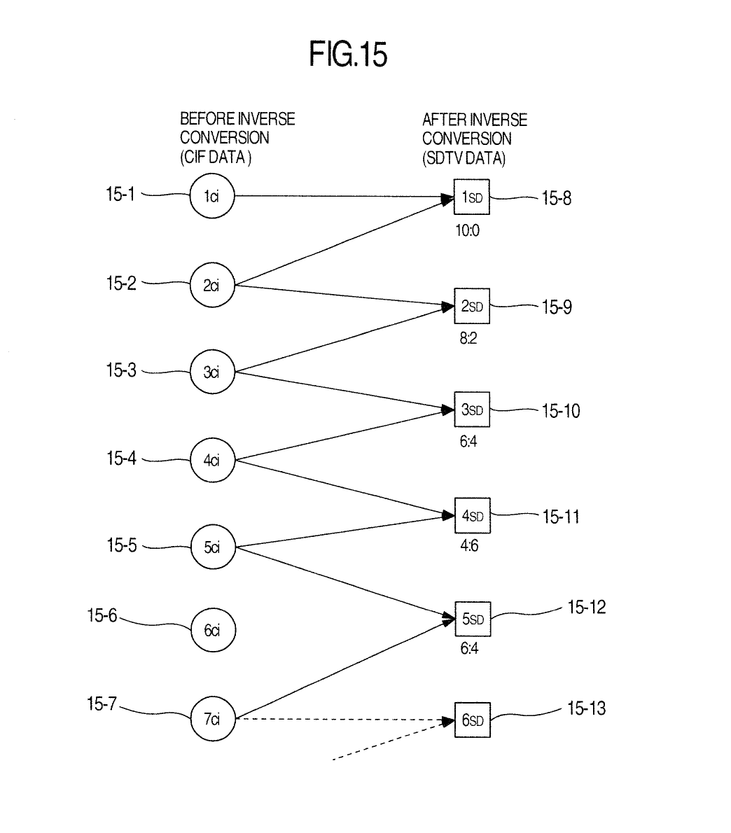

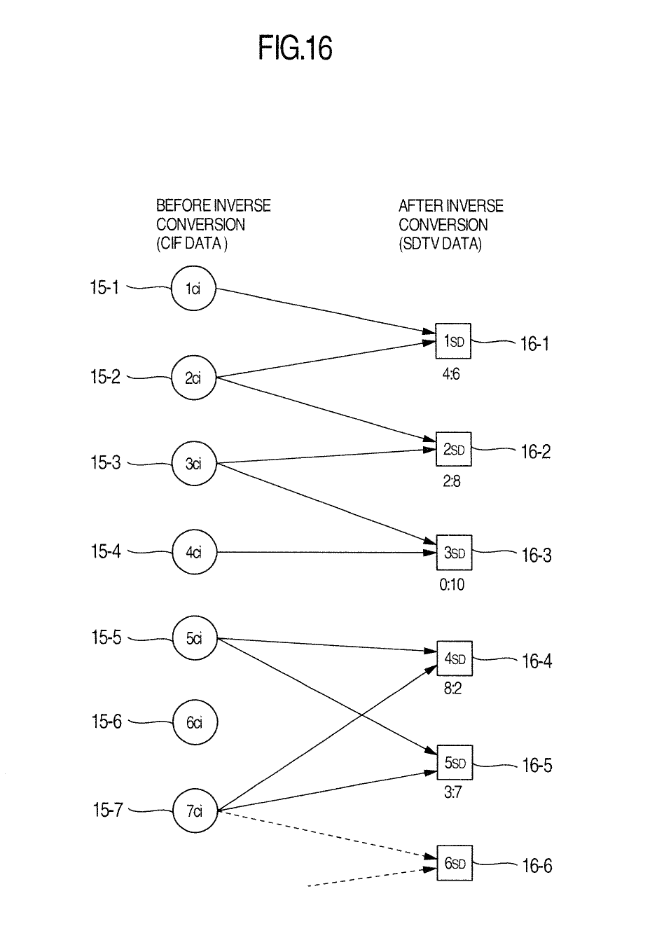

A detailed description will be made of the actual inverse-conversion processing in the converter circuits of the image inverse-conversion processor 1-7 given by FIGS. 13 and 14. FIG. 15 shows the line positions before and after the inverse conversion, and conversion coefficients used when the odd-field data is generated.

Lines 15-1, 15-2, 15-3, 15-4, 15-6, 15-6, 15-7 represent the line positions of CIF data 1-5 before the inverse conversion, and lines 15-8, 15-9, 15-10, 15-11, 15-12, 15-13 the line positions of the odd-field data of the SDTV data 1-8 after the inverse conversion.

The line 15-8 is generated by converting (adding) the lines 15-1 and 15-2 at a pixel component ratio of 10:0. The line 15-9 is generated by adding the lines 15-2 and 15-3 at a pixel component ratio of 8:2. In addition, the line 15-10 is generated by adding the lines 15-3 and 15-4 at a pixel component ratio of 6:4, and the line 15-11 by adding the lines 15-4 and 15-5 at a pixel component ratio of 4:6. The line 15-12 is generated by adding the lines 15-5 and 15-7 at a pixel component ratio of 6:4, and the line 15-6 is not referred to. The 6 lines of CIF data and the 5 lines of SDTV data are respectively used and generated as one cycle of the conversion processing, and the line 15-13 and the following are generated by repeating the above conversion operation with the above period.

FIG. 16 shows the line positions before and after the inverse conversion, and conversion coefficients used when the even-field data is generated. Lines 15-1, 15-2, 15-3, 15-4, 15-6, 15-7 represent the line positions of CIF data 1-5 before the inverse conversion, and lines 16-1, 16-2, 16-3, 16-4, 16-5, 16-6 the line positions of the even-field data of SDTV data after the inverse conversion.

The line 16-1 is generated by converting (adding) the lines 15-1 and 15-2 at a pixel component of 4:6. The line 16-2 is generated by adding the lines 15-2 and 15-3 at a pixel component ratio of 2:8. In addition, the line 16-3 is generated by adding the lines 15-3 and 15-4 at a pixel component ratio of 0:10, and the line 16-4 by adding the lines 15-5 and 15-7 at a pixel component ratio of 8:2. The line 16-5 is generated by adding the lines 15-5 and 15-7 at a pixel component ratio of 3:7, and the line 15-6 is not referred to. The conversion from the 6 lines of CIF data to the 5 lines of SDTV data is performed as one cycle of the conversion processing, and the line 16-6 and the following are generated by repeating the above conversion processing with that period.

FIG. 17 shows the flow of CIF data fed with respect to time and the flow of SDTV data produced with respect to time in the reverse conversion for generating the odd field of SDTV data 1-8 shown in FIG. 15. In FIG. 17, the input timing and output timing of the lines to and from the image inverse-conversion processor 1-7 are shown, and time elapses from left to right.

Lines 17-1, 17-2, 17-3, 17-4, 17-5, 17-6, 17-7 represent the lines of CIF data 1-5 before the inverse conversion, and lines 17-8, 17-9, 17-10, 17-11, 17-12, 17-13 the lines of the odd field of the SDTV data 1-8 after the inverse conversion.

The CIF data 1-5 is fed to the inverse-conversion processor 1-7 each time the monitor 1-9 scans one line.

In the first line period, data of line 17-1 is produced from the CPU 1-3 and stored in the line memory 13-2 of the processor 17. In the next line period, data of line 17-2 is produced from the CPU 1-3. At the same time, the data of line 17-1 stored in the line memory 13-2 of the processor 1-7 is read and the two lines are added to produce data of line 17-8. Thereafter, each time the monitor scans one line, the line 17-9 is generated from the lines 17-2 and 17-3, the line 17-10 from the lines 17-3 and 17-4, and the line 17-11 from the lines 17-4 and 17-5. However, in the sixth line period from the start of the inverse conversion, the CPU 1-3 controls line 17-6 not to be produced but line 17-7 to be produced.

Thus, the line 17-12 is generated from the lines 17-5 and 17-7. The operations mentioned so far is treated as one cycle of the inverse conversion, and further conversion is performed by repeating the cycle. Therefore, for the repetition of conversion, the line 17-7 is used as the line 17-1, and the line 17-13 is generated as the line 17-8.

In this case, when the odd field of SDTV data 1-8 is generated, only one line-memory having a capacity of one line is used within the image inverse-conversion processor 1-7. In addition, since the inverse conversion processing is repeated by using two lines of the line read from the memory of the processor 1-7 and the line fed to the processor 1-7, the control circuit can be simplified.

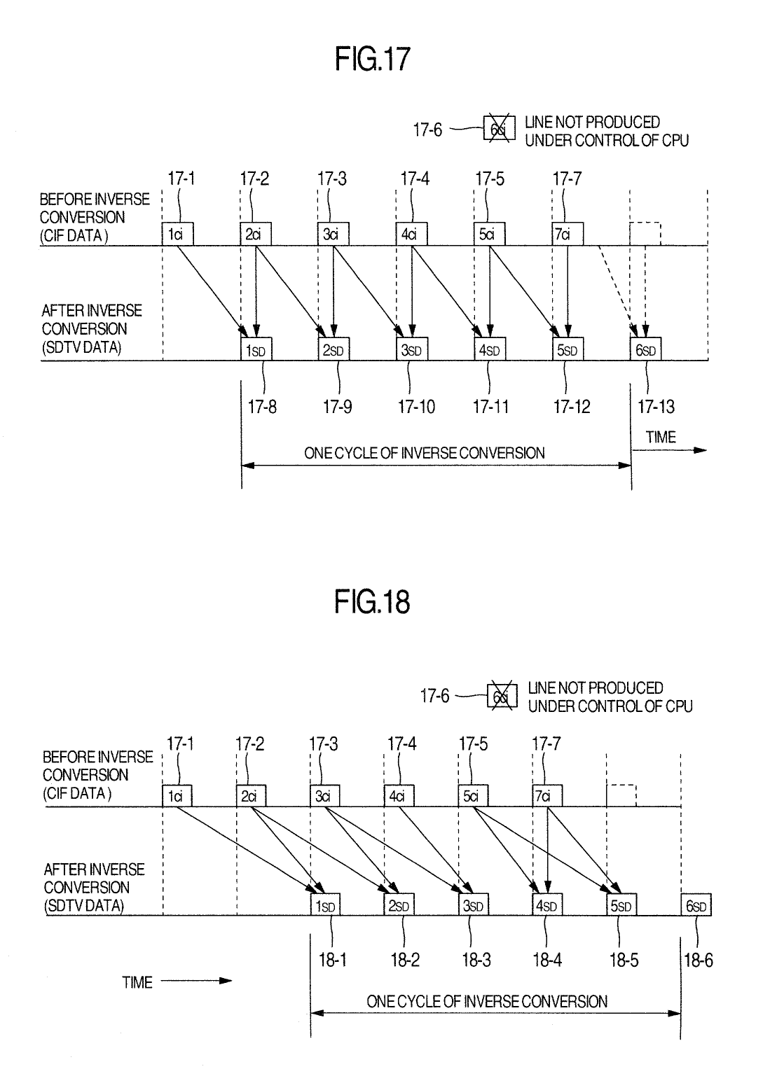

FIG. 18 shows the flow of CIF data fed and SDTV data produced with respect to time in the inverse conversion processing for generating the even field data of SDTV data 1-8 shown in FIG. 16.

Lines 17-1, 17-2, 17-3, 17-4, 17-5, 17-6, 17-7 represent the lines of CIF data 1-5 before the inverse conversion, and lines 18-1, 18-2, 18-3, 18-3, 18-4, 18-5, 18-6 the even field data of SDTV data 1-8 after the inverse conversion.

The CIF data 1-5 is fed to the inverse-conversion processor 1-7 each time the monitor 1-9 scans one line. In the first line period, the CPU 1-3 produces data of line 17-1, and orders the line memory 14-1 of the processor 1-7 to store the data. In the next line period, the CPU 1-3 produces data of line 17-2, and orders the line memory 14-2 of the processor 1-7 to store the data. Further in the next line period, the line 17-1 stored in the line memory 14-1 of the processor 1-7 and the line 17-2 stored in the line memory 14-2 are added for inverse conversion to generate data of line 18-1.

Moreover, in this line period, the CPU 1-3 produces data of line 17-3, and orders the line memory 14-1 of the processor 1-7 to store it. Thereafter, each time the monitor 1-9 scans one line, data of line 18-2 is generated from the lines 17-2 and 17-3, and data of line 18-3 from the lines 17-3 and 17-4.

However, in the sixth line period from the start of the inverse conversion, the line 17-7 is generated under the control of the CPU 1-3. Thus, data of line 18-4 is generated from the lines 17-5 and 17-7.

In the seventh line period from the start of the inverse conversion, the lines 17-5 and 17-7 used by the inverse conversion in the sixth line period are again used to generate data of line 18-5.

The inverse conversion from the 6 lines of CIF data to 5 lines of SDTV data mentioned so far is treated as one cycle of the inverse conversion, and further conversion is performed by repeating this cycle. Therefore, the line 17-7 is used as the line 17-1, and the line 18-6 is generated as the line 18-1.

Thus, in order to convert to the even field of SDTV data 1-8 the construction of FIG. 14 needs two line memories each having a capacity of one line within the inverse conversion processor 1-7 unlike the conversion to the odd field. In addition, since any two lines of the three lines of which the two lines are read from the two line memories of the processor 1-7 and of which the other line is fed to the processor 1-7 are used for the inverse conversion, and since only one line period of the cycle of the inverse conversion is differently controlled, the control circuit scale is increased.

Thus, in the above embodiment as described above, when the frame image formed of one field such as CIF data is converted to a frame image formed of two fields such as SDTV, the lines of the image are thinned out so that the line number of the image before the conversion can be made equal to that of the image to be monitored, thereby making it possible to use only one line memory having a capacity of one line in the inverse conversion to the odd field. However, the conversion to the even field needs two line memories each having a capacity of one line. In addition, since only one line period of the one cycle of the inverse conversion is differently controlled, constant processing repetition is not performed, thus increasing the control circuit scale.

In the image inverse conversion system of this embodiment as described above, when the CIF data of which the lines are thinned out is inversely converted to the odd field of SDTV data, the capacity of the memory used within the inverse conversion processor is small, and thus the control circuit scale can be reduced. However, when the CIF data of which the lines are thinned out is inversely converted to the even field of SDTV, two line memories are used, and only one line of the cycle of the inverse conversion is differently controlled. Thus, the memory capacity of the inverse conversion processor and the control circuit scale cannot be reduced, so that the circuit scale of the inverse conversion processor cannot be sufficiently reduced.

In the embodiments which will be mentioned below, an image decoding apparatus can be produced in which the circuits for use in the inverse conversion to the odd field, and the circuits for use in the inverse conversion to the even field are replaced by common circuits that can reduce the capacity of line memory and the control circuit scale necessary for the image inverse-conversion processor.

An image decoding apparatus of still another embodiment of the invention will be described with reference to FIGS. 1, 12 and 13 and FIGS. 19-21.

The construction of this embodiment is fundamentally the same as the embodiment of FIG. 1, and thus will not be described.

An image processing method for the inverse conversion of CIF data 1-5 to SDTV data 1-8 will be described with reference to FIG. 12. The CPU 1-3 partitions the CIF data 12-4 of 288 lines at every 6 lines, and eliminates one line from each section, thereby thinning out, or decimating the CIF data of 288 lines to produce CIF data 12-5 of 240 lines which is then fed to the memory 1-6. The data of 240 lines stored in this memory 1-6 is transferred to the image inverse-conversion processor 1-7, which makes inverse conversion to produce odd-field data 12-6 of SDTV data 12-8. The even field 12-7 is generated by again transferring the thinned-out CIF data 12-5 stored in the memory 1-6 to the processor 1-7. In other words, the same line as the line eliminated in the conversion to the odd field is eliminated in the data conversion to the even field.

The CIF data 12-5 of 240 lines transferred to the inverse-conversion processor 1-7 in order to be converted to the even-field data 12-7 undergoes inverse conversion different from the data conversion to the odd field to form the even-field data 12-7 of SDTV data 12-8. Since the odd field of pixels of SDTV data 12-8 is different in line positions from the even field thereof, different conversion processing is made for the odd and even fields. The inverse-conversion processor 1-7 combines these two field data to form the SDTV data 12-8 of 480 lines per frame, and supplies it to the monitor 1-9.

While the images before and after the inverse conversion are respectively indicated by CIF data 1-5 and SDTV data 1-8 in FIG. 1, they may be various types of images if the line number is converted as described above.

The circuit arrangement of the inverse-conversion processor 1-7 of the image decoding apparatus according to the invention will be described below. First, the converter circuit for the conversion to the odd field is the same as the circuit arrangement for making the conversion to the odd field mentioned with reference to FIG. 13.

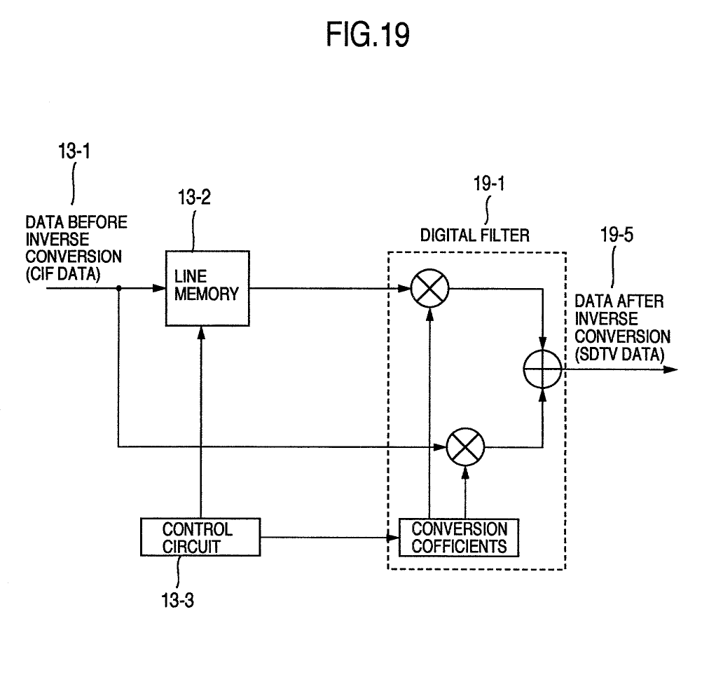

The data converter circuit for the conversion to the even field will be described in detail with reference to FIG. 19. The image inverse-conversion processor 1-7 includes the line memory 13-2, the control circuit 13-3, and a digital filter 19-1.

The data 13-1 before the inverse conversion is fed to the inverse-conversion processor 1-7 each time the monitor 1-9 scans one line. The data 13-1 before the inverse conversion is supplied to the line memory 13-2, and read to be delayed by one line therefrom under the control of the control circuit 13-3.

The one-line delayed data and the data 13-1 not delayed are supplied to the digital filter 19-1, where they are multiplied by conversion coefficients and added to form data 19-2 after the reverse conversion. Thus, the inverse-converter processor 1-7 produces the data 19-2.

Thus, the converter circuit for the conversion to the even field, of the image decoding apparatus of the invention only differs in the digital filter from the converter circuit for the conversion to the odd field (FIG. 13), and thus the line memory and the control circuit can be shared as common circuits by the control circuits for the conversion to the odd and even fields.

A detailed description will be made of the inverse conversion processing in the data converter circuit for the conversion to the even field shown in FIG. 19.

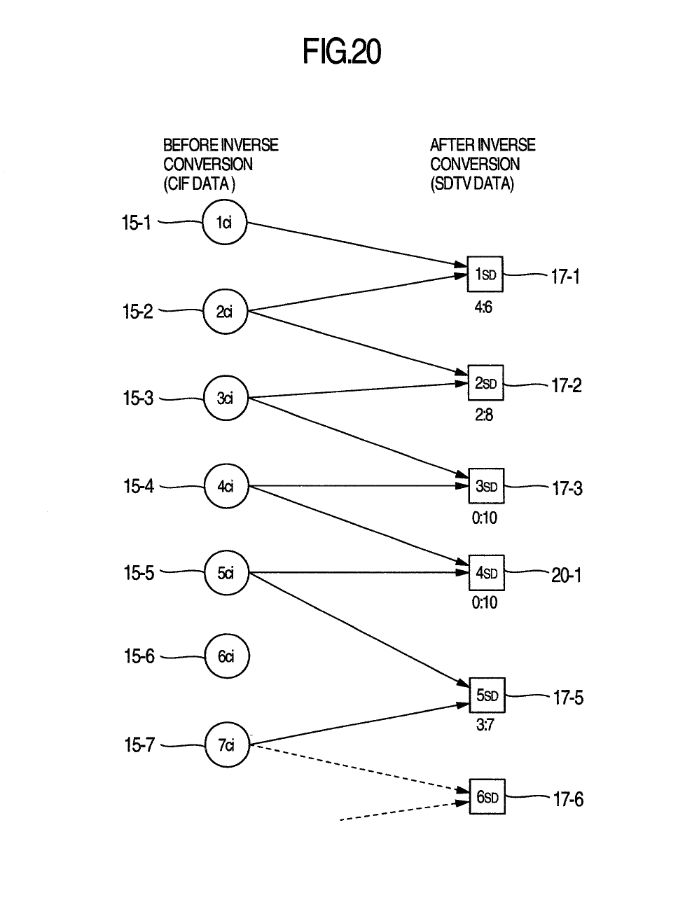

FIG. 20 shows the line positions before and after the inverse conversion and conversion coefficients used when the even field data of SDTV data 1-8 is generated.

Lines 15-1, 15-2, 15-3, 15-4, 15-5, 15-6, 15-7 represent the line positions of CIF data 1-5 before the inverse conversion, and lines 17-1, 17-2, 17-3, 20-1, 17-5, 17-6 the line positions of the even field of SDTV 1-8 after the inverse conversion. The CIF data 1-5 is fed to the inverse-conversion processor 1-7 each time the monitor 1-9 scans one line.

In the first line period, the line 17-1 is generated by adding the lines 15-1 and 15-2 at a pixel component ratio of 4:6. Thereafter, the line 17-2 is generated by adding the lines 15-2 and 15-3 at a pixel component ratio of 2:8, and the line 17-3 by adding the lines 15-3 and 15-4 at a pixel component ratio of 0:10.

The line 20-1 is generated by adding the lines 15-4 and 15-5 at a pixel component ratio of 0:10 in this embodiment unlike the inverse conversion of the embodiment mentioned with reference to FIG. 16 in which the lines 15-5 and 15-7 are added at a pixel component ratio of 8:2. With the ratio 0:10, the pixel component resulting from this conversion provides the minimum difference from that obtained by adding the lines at the original pixel component ratio of 8:2. The line 17-5 is generated by adding the lines 15-5 and 15-7 at a pixel component ratio of 3:7 with the line 15-6 not referred to. The line 17-6 and the following are generated by repeating the above conversion method.

By changing the conversion coefficients to add at such ratios, it is possible to use a common conversion procedure for the conversion to the odd and even fields.

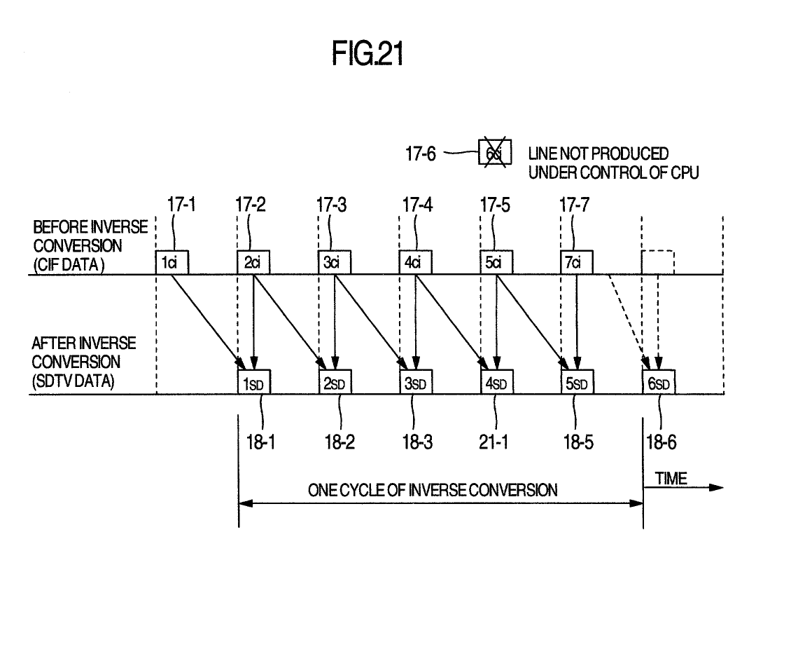

FIG. 21 shows the flow of CIF data fed and flow of SDTV data produced with respect to time in the inverse conversion processing for generating the even field of SDTV data 1-8 shown in FIG. 20.

The image inverse-conversion processor 1-7 receives the lines of CIF data and produces the lines of SDTV data, and time elapses from left to right as shown in FIG. 21. Lines 17-1, 17-2, 17-3, 17-4, 17-5, 17-6, 17-7 represent the lines of CIF data 1-5 before the inverse conversion, and lines 18-1, 18-2, 18-3, 21-1, 18-5, 18-6 the data of even field of SDTV data after the inverse conversion. The CIF data 1-5 is fed to the inverse-conversion processor 1-7 each time the monitor 1-9 scans one line.

In the first line period, the line 17-1 is generated from the CPU 1-3, and stored in the line memory 13-2 of the inverse-conversion processor 1-7. In the next line period, the line 17-2 is produced from the CPU 1-3, and at the same time, the line 17-1 stored in the line memory 13-2 of the processor 1-7 is read out and added to the line 17-2, so that the line 18-1 is generated from the two lines by the inverse conversion processing.

Thereafter, each time the monitor 1-9 scans one line, the line 18-2 is generated from the lines 17-2 and 17-3, the line 18-3 from the lines 17-3 and 17-4, and the line 21-1 from the lines 17-4 and 17-5 in accordance with the output rate to the monitor 1-9. However, in the sixth line period from when the line 17-1 is fed to the processor 1-7, the line 17-6 is not supplied, but the next line 17-7 is supplied under the control of the CPU 1-3.

Thus, the line 18-5 is generated from the lines 17-5 and 17-7. The operation mentioned so far is treated as one cycle of the inverse conversion, and further conversion is performed by repeating this cycle. Therefore, the line 17-7 is generated as the line 17-1, and the line 18-6 as the line 18-1 in the repeating manner.

Thus, for the conversion to the even field of SDTV data 1-8 only a line memory having a capacity of one line is provided within the inverse-conversion processor 1-7 in the same way as for the conversion to the odd field. In addition, the inverse conversion procedure is the same as for the odd field. Since the two lines of the line read from the line memory 13-2 of the processor 1-7 and the line fed to the processor 17 are similarly processed for the conversion in each line period, the control circuit can be simplified.

Thus, according to the image data conversion apparatus of the invention, the conversion coefficients for the conversion to the SDTV data are changed in order that a common processing procedure can be used for the conversion to both odd and even fields. That is, the conversion coefficient ratio used for the generation of one line of SDTV data in each cycle of the inverse conversion to the even field is changed from 8:2 to 0:10. By the change of the conversion coefficient, it is possible to use only one line memory having a capacity of one line even for the conversion to the even field as for the conversion to the odd field of SDTV data 1-8. In addition, since the inverse conversion processing is the repetition of the conversion processing on the two lines of the line read from the line memory of the inverse-conversion processor and the line fed to the processor, the converter circuit can be formed of a simple control circuit.

Thus, according to the embodiments of the invention, the lines of data to be decoded are thinned out so that the line frequency of the data can be made equal to that of the receiver, and the conversion coefficient for the conversion to a particular line of the data to be decoded is changed so that the inverse conversion can be performed as the repetition of constant processing, thereby reducing the capacity of line memory for use in the inverse conversion, and the scale of the control circuit for controlling the line memory to write and so on.

While the invention has been particularly described and shown with reference to the embodiments thereof, it will be understood by those skilled in the art that various changes in form and detail and omissions may be made therein without departing from the scope of the invention.

What is claimed is:

1. An image data conversion apparatus for converting transmitted compressed image data to image data of a different format and displaying the converted image data on a display apparatus, comprising:
a first signal processing unit for receiving and decoding said compressed image data;
a recording unit for recording said decoded image data, said recording unit reading out said image data one line by one line at a scanning line period of said display apparatus under control of said first signal processing unit; and
a second signal processing unit for converting image data read out of said recording unit to image data of a screen size of said display apparatus.

2. An image data conversion apparatus according to claim 1, wherein said first signal processing unit includes a decimation processing section for decimating said decoded image data to eliminate certain lines from said decoded image data so that image data of a same number of lines as that of the display apparatus be read out from said recording unit.

3. An image data conversion apparatus according to claim 1, wherein said first signal processing unit includes a central processing unit (CPU).

4. An image data conversion apparatus according to claim 3, wherein said CPU includes an expansion processing section for expanding said inputted compressed image data.

5. An image data conversion apparatus according to claim 2, wherein said decoded image data from said first signal processing unit is of CIF type.

6. An image data conversion apparatus according to claim 5, wherein a size of the image to be displayed on said display apparatus is SDTV.

7. An image data conversion apparatus according to claim 6, wherein said recording unit eliminates data of every sixth line of said decoded image data of CIF type.

8. An image data conversion apparatus according to claim 7, wherein each time data of one line is read out from said recording unit, said second signal processing unit adds said read data and data one line before at a predetermined ratio to generate image data of one line to be displayed on said display apparatus.

9. An image data conversion apparatus according to claim 1, wherein said inputted compressed data is of MPEG-4 compression type image data.

10. An image data conversion apparatus for converting compressed image data transferred in units of a field to image data of a different format so as to be displayed on a display apparatus, comprising:
a first signal processing unit for receiving said compressed image data in units of a field and decoding said compressed image data;
a recording unit for recording said decoded image data, said recording unit reading out said image data one line by one line at a scanning line period of said display apparatus under control of said first signal processing unit; and
a second signal processing unit for converting image data read out of said recording unit to image data of a screen size of said display apparatus, said second signal processing unit including an inverse converter for converting said image data of each field to an odd field image data and an even field image data.

11. An image data conversion apparatus according to claim 10, wherein a type of image read out from said recording unit is CIF, and a size of image to be displayed on said display apparatus is SDTV.

12. An image data conversion apparatus according to claim 10, wherein said inverse converter includes a line memory by which said image data of each line read out from said recording unit is delayed by one line, and a digital filter that receives image data of a current line and said image data read one line before from said line memory, multiplies said both data by predetermined conversion coefficients, respectively, and then adds those data.

13. An image data conversion apparatus according to claim 10, wherein said first signal processing unit includes a decimation processing section that decimates the decoded image data to eliminate predetermined lines from the decoded image data so that image data having a same number of lines as that of an odd field or an even field of said display apparatus is read out from said recording unit.

14. An image data conversion apparatus according to claim 13, wherein said predetermined lines eliminated from said image data are same lines for the odd and even fields.

15. An image data conversion apparatus according to claim 10, further comprising a bus for connecting said first and second signal processing units, wherein said recording unit is connected to said bus, and wherein said image data from said first signal processing unit is once stored in said recording unit and then read at every line so as to be supplied to said second signal processing unit.

16. An image data conversion method for converting transmitted compressed image data to image data of a different format and displaying the converted image data on a display apparatus, comprising the steps of:
decoding said compressed image data;
recording said decoded image data;
reading said recorded image data one line by one line at a scanning line period of said display apparatus; and
converting image data read out of said recording unit to image data of a screen size of said display apparatus.

17. An image data conversion method according to claim 16, wherein said step of reading includes decimating said decoded image data to eliminate predetermined lines so that image data having the same number of lines as that of said display apparatus is read out.

18. An image data conversion method according to claim 17, wherein said image data read out is of CIF type.

19. An image data conversion method according to claim 17, wherein said image data displayed on said display apparatus is of SDTV type.

20. An image data conversion method according to claim 18, wherein said step of reading includes decimating said decoded image data of CIF type to remove every sixth line of said decoded image data of CIF type.

21. An image data conversion method according to claim 20, wherein said step of converting includes, each time data of one line is read, adding said read data and data one line before at a predetermined ratio to thereby produce one line of image data to be displayed on said display apparatus.

22. An image data conversion method according to claim 16, wherein said compressed image data is of CIF type, said screen size of said display apparatus is SDTV having each frame constituted by odd and even fields, and said step of converting includes converting said read image data of CIF type to image data of odd field, and then to image data of even field.

23. An image data conversion method according to claim 22, wherein said step of converting includes delaying each line of said read image data by one line period by storing said line in a line memory, multiplying image data of a current line and image data one line before by predetermined conversion coefficients, respectively, and adding said multiplied data in a digital filter.

24. An image data conversion method according to claim 22, wherein said step of reading includes decimating said decoded image data to remove predetermined lines so that image data having a same number of lines as that of an odd field or an even field of said display apparatus is generated.

25. An image data conversion method according to claim 24, wherein said predetermined lines removed from said decoded image are same lines for the odd and even fields.

26. An image data conversion method according to claim 22, wherein said decoded image data is once stored in a recording unit and then read line by line.
